(19) United States
(12) Patent Application Publication
(10) Pub. No.: US 2003/0041109 A1
(43) Pub. Date: Feb. 27, 2003

(54) Method and apparatus for distance learning and workgroup collaboration utilizing the world wide web

(76) Inventors: Ryan K. Meloni, Huntington Station, NY (US); Guillaume Malignon, Flushing, NY (US)

Correspondence Address: Thomas M. Galgano, Esq., GALGANO & BURKE, Suite 135, 300 Rabro Drive, Hauppauge, NY, 11788, US

(21) Appl. No.: 10/163,726

(22) Filed: Jun. 5, 2002

Related U.S. Application Data
(60) Provisional application No. 60/310,734, filed on Aug. 9, 2001.

(51) Int. Cl. G06F 15/16

(52) U.S. Cl. 709/205

(57) ABSTRACT

At least one instructor workstation and a plurality of student workstations are coupled to a communication network. A Microsoft server includes an SMTP mail server, a streaming media server, and a file transfer protocol (FTP) server. An ECS includes a chat server, a calls server, and an assessment server. The ECS is coupled. to the Microsoft server by a JAVA virtual machine. According to the presently preferred embodiment, the Microsoft server is also provided with a “SnapStream PVS Personal Video Station software plus Streaming Video Server”, a central database, a proxy web server, an XML based Simple Object Access Protocol (SOAP) server and a filter. The Enterprise Communication Server is responsible routing commands and messages between clients. The FTP server is used as temporary storage and file transfer protocol for uploading/downloading files between clients. The SMTP server is used to retrieve e-mail messages between clients. The SOAP server “streams” to the clients the coordinates of the drawings drawn on an instructor's screen. The database server is a central data collector where all the clients store any relevant information in the database. The database server is also used for authentication purposes. The Windows Media server is used for receiving and streaming multimedia content from the PVS to the clients.

This application claims the benefit of provisional application Serial Number 60/310,734 filed Aug. 9, 2001.

### BACKGROUND OF THE INVENTION

1. Field of the Invention

The invention relates to computer network based communications systems for education or collaboration. More particularly, the invention relates to distance learning and workgroup collaboration software with synchronized web page navigation.

2. State of the Art

The use of computers in education is no longer an expensive option, but is now a standard. There are many different uses for computers in the classroom and outside the classroom in the furtherance of education.

There are many products available for use in the classroom where a group of student computers can be synchronized to the instructor's computer so that all the students view the same information at the same time. However, these systems are limited in the number of computers supported and in the location of the computers. Typically these systems operate with a group of computers in the same room coupled to each other by an Ethernet network or by parallel cables.

One of the new and interesting uses of computers outside the classroom is known as “distance learning”. Distance learning addresses certain issues that have limited traditional education. These issues include: fixed schedules, passive learning, physical campus, teacher:student ratio, etc. One limitation of the prevailing educational model is that it is available only to people who are at the same physical location. Schools spend money and time providing alternative educational arrangements for homebound children, and loose money by not being able to provide extended educational courses or resources to a larger population than just a geographically dedicated population.

Existing systems for distance learning and course offering have not been able to harness the teaching techniques and material of education institutions. Existing methods generally require that a learner become self taught with periodic assessments by the distance learning institution.

### SUMMARY OF THE INVENTION

It is therefore an object of the invention to provide methods and apparatus for distance learning.

It is also an object of the invention to provide methods and apparatus for distance learning which utilize the Internet.

It is another object of the invention to provide methods and apparatus for distance learning which utilize electronic mail and internet file transfer protocol.

It is still another object of the invention to provide methods and apparatus for distance learning which permit the instructor to synchronize student web browsers.

It is also an object of the invention to provide methods and apparatus for distance learning which permit the instructor to control the students' user interface.

It is another object of the invention to provide methods and apparatus for distance learning which allow for streaming multimedia and remote drawing tools.

It is still another object of the invention to provide methods and apparatus for distance learning which permit user authentication and chat messaging.

It is also an object of the invention to provide methods and apparatus for distance learning which permit student assessment.

It is still another object of the invention to provide methods and apparatus for workgroup collaboration with synchronized web browsers.

In accord with these objects which will be discussed in detail below, the apparatus of the present invention includes at least one instructor workstation and a plurality of student workstations coupled to a communication network. The apparatus also includes a “Microsoft 2000” server and an enterprise communication server (ECS). The Microsoft server includes an SMTP mail server, a streaming media server, and a file transfer protocol (FTP) server. The ECS includes a chat server, a calls server, and an assessment server. The ECS is coupled to the Microsoft server by a JAVA virtual machine. According to the presently preferred embodiment, the Microsoft server is also provided with a “SnapStream PVS Personal Video Station software plus Streaming Video Server”, a central database, a proxy web server, an XML based Simple Object Access Protocol (SOAP) server and a filter.

The different servers are used for the following purpose. The Enterprise Communication Server is responsible routing commands and messages between clients. The FTP server is used as temporary storage and file transfer protocol for uploading/downloading files between clients. The SMTP server is used to retrieve e-mail messages between clients. The SOAP server “streams” to the clients the coordinates of the drawings drawn on an instructor's screen. The database server is a central data collector where all the clients store any relevant information in the database. The database server is also used for authentication purposes. The Windows Media server is used for receiving and streaming multimedia content from the PVS to the clients.

The instructor's workstation communicates with the student workstations using the Enterprise Communication Server and different applications utilize the different servers available to retrieve and/or send the appropriate media as described in more detail below.

Additional objects and advantages of the invention will become apparent to those skilled in the art upon reference to the detailed description taken in conjunction with the provided figures.

### BRIEF DESCRIPTION OF THE DRAWINGS

FIG. 1 is a pictorial schematic diagram illustrating the overall architecture of the invention;

FIG. 2 is a diagram similar to FIG. 1 illustrating the transfer of email using the system of the invention;

FIG. 2a is a flowchart illustrating the transfer of email according to the invention;

FIG. 3 is a diagram similar to FIG. 1 illustrating file transfer using the system of the invention;

FIG. 3a is a flowchart illustrating file transfer protocol according to the invention;

FIG. 4 is a diagram similar to FIG. 1 illustrating web browser synchronization using the system of the invention;

FIG. 4a is a flowchart illustrating the synchronization of web browsers according to the invention;

FIG. 5 is a diagram similar to FIG. 1 illustrating instructor control of the student user interface using the system of the invention;

FIG. 5a is a flowchart illustrating control of the student user interface by the instructor according to the invention;

FIG. 6 is a diagram similar to FIG. 1 illustrating user authentication using the system of the invention;

FIG. 6a is a flow chart illustrating the authentication process according to the invention;

FIG. 7 is a diagram similar to FIG. 1 illustrating multimedia on demand using the system of the invention;

FIG. 7a is a flowchart illustrating the streaming of multimedia according to the invention;

FIG. 8 is a diagram similar to FIG. 1 illustrating content filtering using the system of the invention;

FIG. 8a is a flow chart illustrating content filtering according to the invention;

FIG. 9 is a diagram similar to FIG. 1 illustrating drawing tools using the system of the invention;

FIG. 9a is a flow chart illustrating use of the drawing tools according to the invention;

FIG. 10 is a diagram similar to FIG. 1 illustrating chat messaging using the system of the invention;

FIG. 10a is a flowchart illustrating chat messaging according to the invention;

FIG. 11 is a diagram similar to FIG. 1 illustrating student assessment using the system of the invention;

FIG. 11a is a flowchart illustrating student assessment according to the invention;

FIG. 12 is a diagram similar to FIG. 1 illustrating another embodiment of web browser synchronization using the system of the invention; and

FIG. 12a is a flowchart illustrating the synchronization of web browsers according to the invention as illustrated in FIG. 12.

### BRIEF DESCRIPTION OF THE APPENDICES

The enclosed CD-ROM appendix is incorporated herein by reference. The CD-ROM is in ISO 9660 Macintosh® format and includes the following ASCII Text files:

| | | |
|---|---|---|
| List of files | Size (Bytes) | Date of Creation |

In the directory entitled Server

| | | |
|---|---|---|
| ClientHandler.java | 680 | February 13, 2002 |
| ECSClient.java | 11483 | March 4, 2002 |
| Server.java | 23779 | March 6, 2002 |
| ServerHandler.java | 983 | February 13, 2002 |

In the directory entitled Student and Instructor Client

| | | |
|---|---|---|
| ClientHandler.java | 680 | February 13, 2002 |
| ECSClient.java | 12214 | March 27, 2001 |
| AlarmClock.java | 2427 | March 25, 2002 |
| AlarmTask.java | 610 | April 29, 2002 |
| PanelApplet.java | 3477 | March 25, 2002 |
| ShowAlarmWindow.java | 2417 | April 29, 2002 |
| SoundLoaderThread.java | 1576 | March 25, 2002 |
| TimeDropDown.java | 2042 | April 29, 2002 |
| TimeThread.java | 4280 | March 25, 2002 |
| WindowApplication.java | 5376 | March 25, 2002 |
| DataSource.java | 2545 | April 29, 2002 |
| LiveStream.java | 5560 | April 29, 2002 |
| Database.java | 8197 | April 24, 2002 |
| FTPClient.java | 11003 | April 29, 2002 |
| FTPControlSocket.java | 5107 | April 29, 2002 |
| FTPException.java | 128 | April 29, 2002 |
| FTPTransferType.java | 298 | April 29, 2002 |
| FTpInstructorTest.java | 1095 | March 25, 2002 |
| FTPStudentTest.java | 1248 | March 25, 2002 |
| Jutil.java | 10656 | March 25, 2002 |
| _Broadcast.java | 1089 | March 19, 2002 |
| Broadcast.java | 482 | April 29, 2002 |
| _MPlayer.java | 227 | March 19, 2002 |
| MPlayer.java | 484 | March 19, 2002 |
| _Class_OpenFile.java | 951 | March 20, 2002 |
| AVReceive2.java | 12832 | March 20, 2002 |
| Browser.java | 49271 | April 29, 2002 |
| ChatPanel.java | 2298 | April 29, 2002 |
| Class_OpenFile.java | 527 | March 20, 2002 |
| ClassFoldersDialog.java | 8183 | April 29, 2002 |
| ClassRoomView.java | 21094 | March 28, 2001 |
| CoursesDialog.java | 16004 | March 27, 2001 |
| CoursesPasswordsDialog.java | 7737 | April 29, 2002 |
| EmailDetail.java | 1413 | March 25, 2002 |
| FtpDetail.java | 1289 | April 2, 2002 |
| FTPSend.java | 6725 | March 4, 2002 |
| InBox.java | 4414 | March 23, 2002 |
| InstructorRegistrationWizard.ja | 26603 | April 29, 2002 |
| Interface.java | 101225 | April 29, 2002 |
| LoginDialog.java | 15039 | April 24, 2002 |
| MesgWindow.java | 4207 | April 17, 2002 |
| MesgWindowSp.java | 18624 | April 25, 2002 |
| MiscMail.java | 2978 | April 29, 2002 |
| MultimediaPlayer.java | 2704 | March 28, 2002 |
| MyCellRenderer.java | 1110 | April 29, 2002 |
| NewClassDialog.java | 5409 | April 29, 2002 |
| NewFolderDialog.java | 3568 | April 29, 2002 |
| OpenFile.java | 2555 | March 23, 2002 |
| OutBox.java | 14163 | April 2, 2002 |
| PreferencesDialog.java | 22792 | March 23, 2002 |
| QuestionArchive.java | 7880 | March 26, 2002 |
| QuestionDialog.java | 45305 | March 27, 2001 |
| RemoteDialog.java | 5793 | April 29, 2002 |
| ReportDialog.java | 22970 | March 14, 2002 |
| SendMail.java | 8478 | March 28, 2001 |
| SplashWindow.java | 1306 | April 29, 2002 |
| Stream.java | 2650 | March 28, 2001 |
| StudentBrowser.java | 23916 | March 27, 2002 |
| StudentRegistrationWizard.java | 24345 | April 29, 2002 |
| TakeAttendance.java | 1757 | April 29, 2002 |
| TimerDialog.java | 12371 | March 20, 2002 |
| Tooltip.java | 3470 | March 26, 2002 |
| UserInfoWindow.java | 5467 | March 24, 2002 |
| UserList.java | 2190 | April 29, 2002 |
| Ved.java | 5171 | April 29, 2002 |
| VideoTransmit.java | 7262 | April 29, 2002 |
| ViewAttendance.java | 8322 | April 29, 2002 |
| VisitedLinks.java | 1803 | April 29, 2002 |
| TestFolders.java | 2446 | February 8, 2002 |

In the directory entitled Highlighted code are the following
Adobe ® Acrobat ® files:

| | | |
|---|---|---|
| Browser.pdf | 44951 | May 4, 2002 |
| ClientHandler.pdf | 2412 | May 4, 2002 |
| ECSClient.pdf | 13634 | May 4, 2002 |
| Interface.pdf | 75848 | May 4, 2002 |
| Server.pdf | 20076 | May 4, 2002 |
| ServerHandler.pdf | 2992 | May 4, 2002 |

### DETAILED DESCRIPTION OF THE PREFERRED EMBODIMENTS

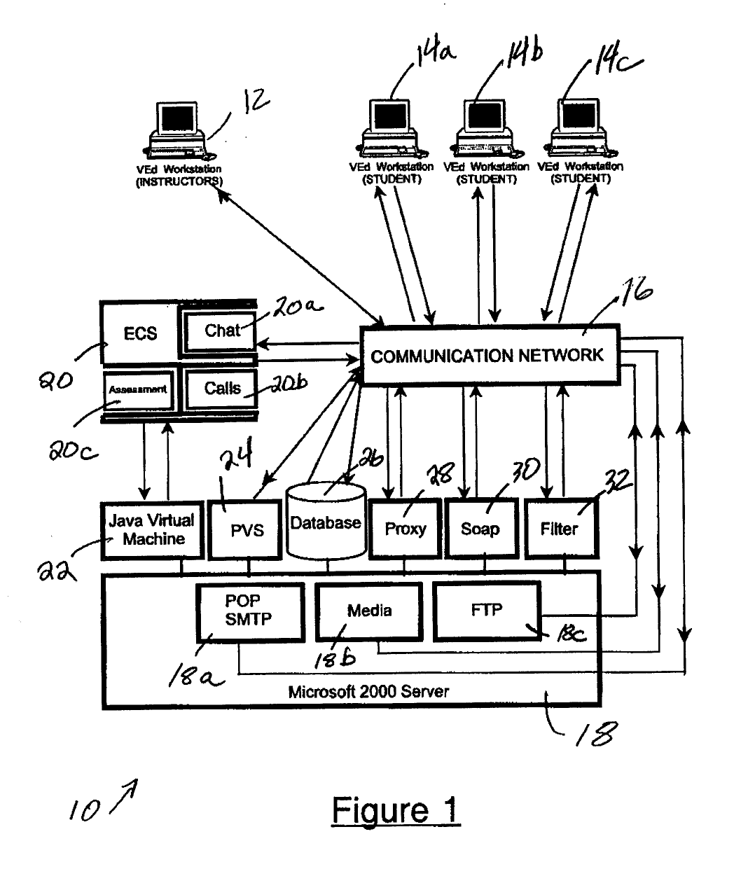

Referring now to FIG. 1, a system 10 according to the invention includes at least one instructor workstation 12 and a plurality of student workstations, e.g. 14A-14c coupled to a communication network 16. As used herein, the term “group leader” may be substituted for “instructor” and the term “group member” may be substituted for “student”. The system 10 also includes a “Microsoft 2000” server 18 and an enterprise communication server (ECS) 20. The Microsoft server 18 includes an SMTP mail server 18a, a streaming media server 18b, and a file transfer protocol (FTP) server 18c. The ECS 20 includes a chat server 20a, a calls server 20b, and an assessment server 20c. The ECS 20 is coupled to the Microsoft server 18 by a JAVA virtual machine 22. According to the presently preferred embodiment, the server 18 is also provided with a “SnapStream PVS Personal Video Station software plus Streaming Video Server” 24, a central database 26, a proxy web server 28, an XML based Simple Object Access Protocol (SOAP) server 30 and a filter 32.

The different servers are used for the following purpose. The Enterprise Communication Server 20 is responsible routing commands and messages between clients (i.e. workstations 12 and 14a-14c). The FTP server 18c is used as temporary storage and file transfer protocol for uploading/downloading files between clients. The SMTP server 18a is used to retrieve e-mail messages between clients. The SOAP server 30 “streams” to the clients the coordinates of the drawings drawn on an instructor's screen. The database server 26 is a central data collector where all the clients store any relevant information in the database. The database server 26 is also used for authentication purposes. The Windows Media server 18b is used for receiving and streaming multimedia content from the PVS 24 to the clients.

The instructor's workstation 12 communicates with the student workstations 14a-14c using the Enterprise Communication Server 20 and different applications utilize the different servers available to retrieve and/or send the appropriate media as described in more detail below.

Those skilled in the art will appreciate that the hardware of the invention is readily available off-the-shelf equipment and that the invention's methods and apparatus lie in the JAVA software implementation shown in the above referenced appendices. The particular software implementation in JAVA is presently preferred. However, those skilled in the art will appreciate that the invention could be carried out using other software languages such as C, C++, Visual Basic, JAVASCRIPT, etc. Thus, the following descriptions refer to the functional aspects of the invention rather than any particular implementation of these functions.

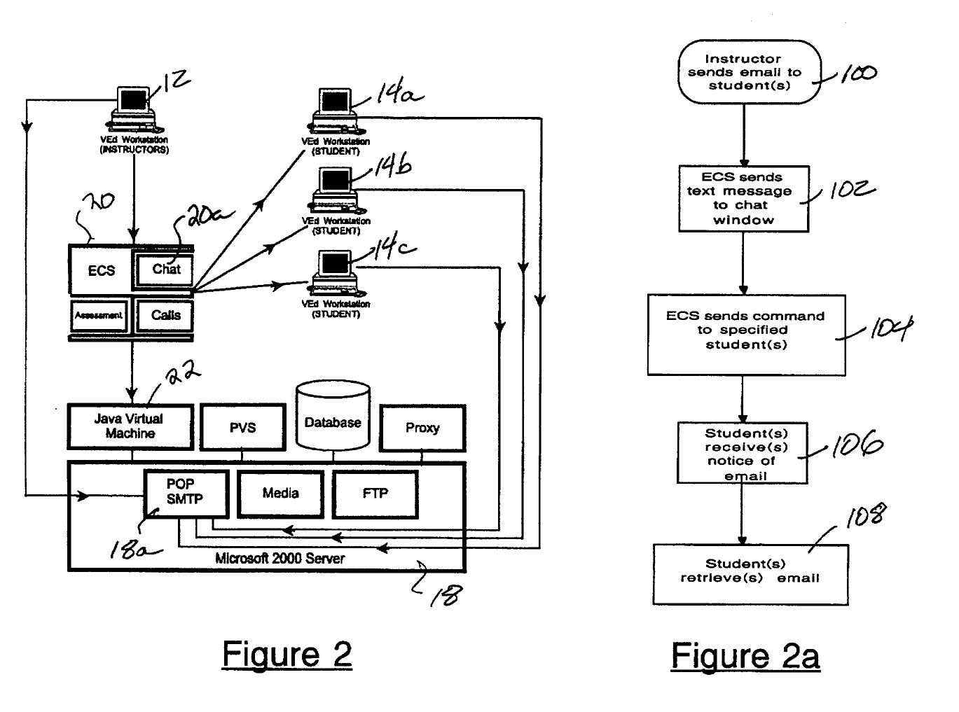

The system of the invention permits communication between the instructor and the students via chat and email. FIGS. 2 and 2a illustrate the transfer of email from the instructor workstation 12 to one of the student workstations 14 (a-c). Referring to the flowchart in FIG. 2a and the pictorial flow diagram of FIG. 2, the instructor workstation 12 sends email to a student 14 as indicated at 100 in FIG. 2a. The ECS 20 sends a text message to the chat window of the student workstation 14 as indicted at 102. The ECS 20 then sends a command to the specified student(s) recipient(s) of the email as indicated at 104. The student(s) then receive(s) notice of the email at 106 and retrieve(s) the email at 108.

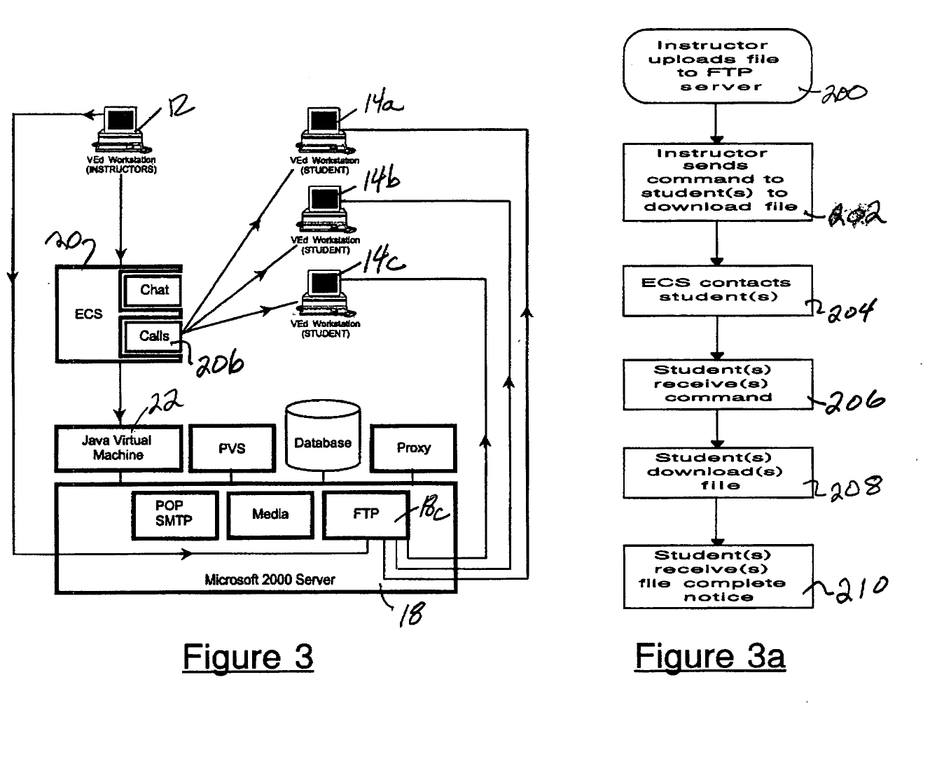

FIGS. 3 and 3a illustrate the different steps that the instructor application must take in order to send a file (File Transfer Protocol) to the clients. The file is first sent 200 to the specified FTP server 18c for temporary storage. As soon as the file has been successfully transferred, the software posts a message in the interface's message window to inform the user the file was transferred successfully and sends the command to the ECS 20 along with a list of clients the file was sent to. The ECS 20 then sends the command to retrieve the file on the FTP Server 18c to each client in the list 202, 204. When the client receives the command 206, the software then retrieves the file 208 from the server and posts a message 210 in the interface's message window informing the user that he/she has received a file in the his/her inbox. The file can then be opened by the user at any time.

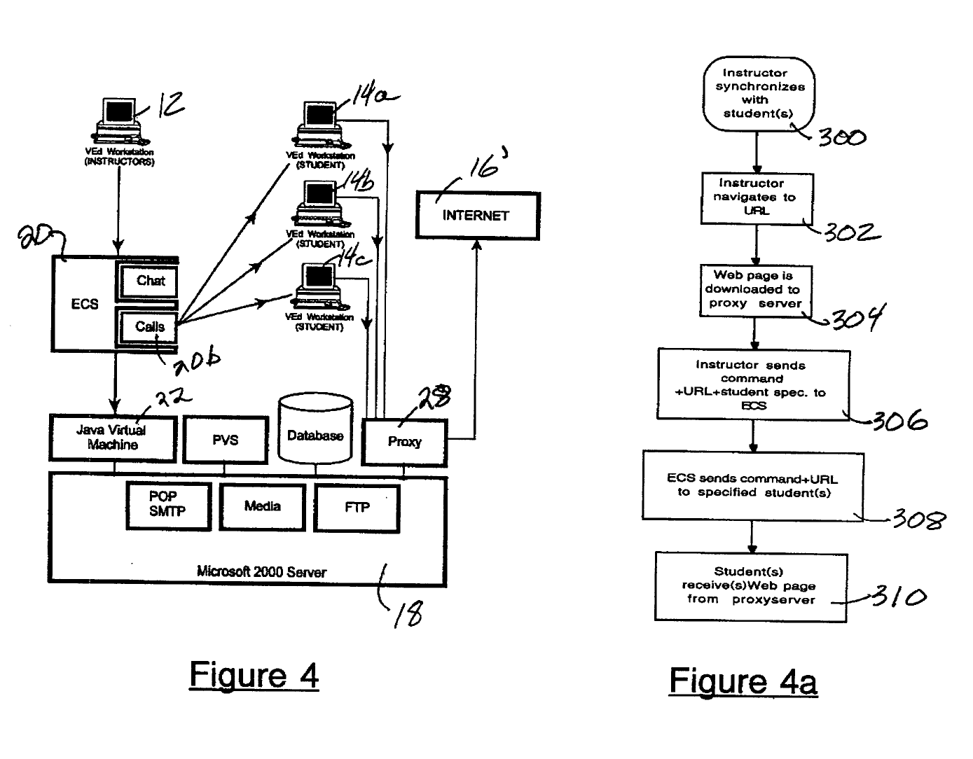

FIGS. 4 and 4a illustrate one embodiment of the browser synchronization according to the invention. Whenever the instructor 12 application is asked to navigate to a web site and synchronization is enabled 300, the application contacts the proxy server 28 which checks if a previously cached copy exists. If the site has not been visited recently, the proxy server retrieves the web site from the internet 302. The instructor then waits until the whole web page, including images, is received 304 to insure it will be cached locally on the proxy server 28. As soon as the web page is fully loaded, the instructor software then proceeds to send a command 306 to the Enterprise Communication Server 20 containing the URL and the names of the students to retrieve it. The Enterprise Communication Server 20 then sends the command to the destination clients 308. The clients' software then contact the proxy server 28 to obtain the locally cached copy of the web page 310. This alleviates the strain imposed on an internet connection as the web page only has to be downloaded once and also ensures that the students are viewing the same page as the instructor. The portions of the software responsible for web page synchronization are highlighted in the Acrobat® files of the CDROM appendix.

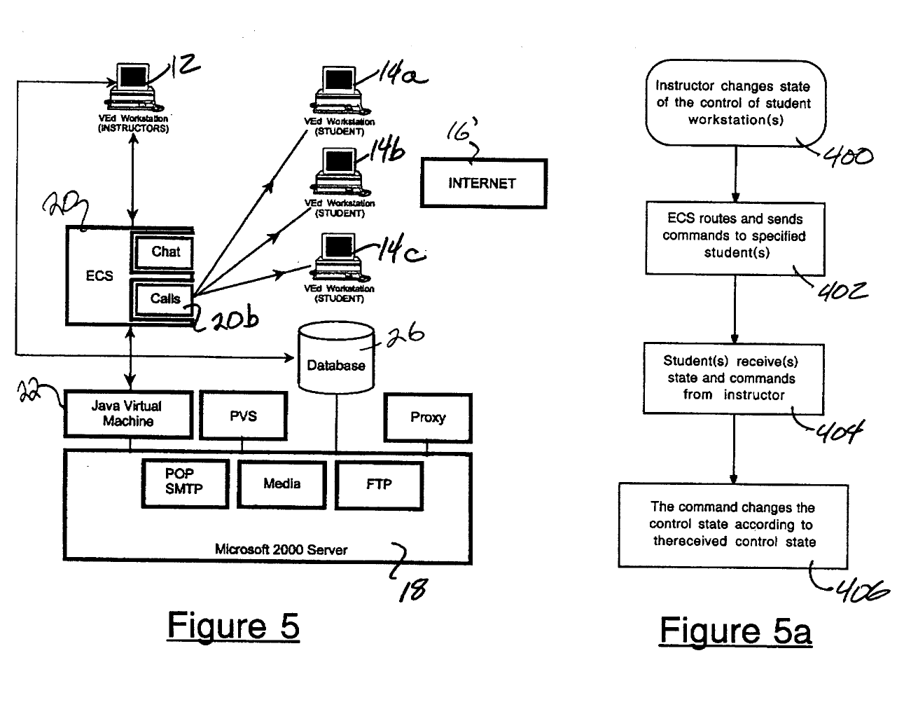

FIGS. 5 and 5a illustrate how the instructor 12 controls access privileges of the students 14a-c. The instructor, with the help of a dialog box containing the list of controls, updates the control state on the students' workstations at 400 which can be applied to the whole class or on any number of students. Immediately after the controls are updated, the instructor software sends the command with the updated list of control states and the list of targeted students to the Enterprise Communication Server. The Enterprise Communication Server then sends the command to the targeted students 402. When the students' software receive the command 404, the list of controls is traversed and each control's state is then updated accordingly 406.

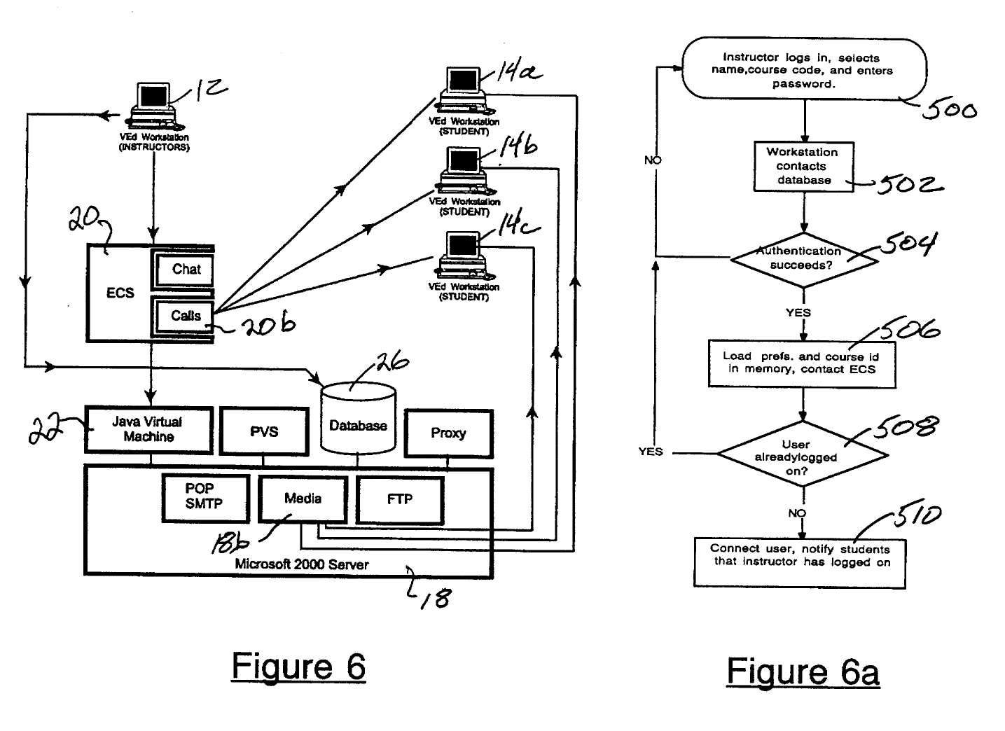

FIGS. 6 and 6a illustrate the authentication process of the invention. Each client using the system has a unique ID combined with a password which is stored in the database 26 along with demographics info and other information pertaining to the course they are following according to the user type. When a client 14a-14c logs in, he/she enters the client ID and password. In the case of the instructor, the instructor selects his/her name from a combo box and the course they are going to teach and enters his/her password 500. The software then opens a stored procedure 502 on the database which compares the user ID and password combination entered and the data stored on the database 504. If the client is authenticated, the client then proceeds to register itself with the Enterprise Communication Server 506. The Enterprise Communication Server 20 then goes through the combination of course ID and user ID to check for duplicated users (if the user is already logged in) 508. If the user is already logged in, it then displays a dialog box alerting them of the issue. If the user is not already logged in, the registration process with the Enterprise Communication Server proceeds to obtain the list of currently connected clients in that particular course. The software then checks the user type and generates the interface according to whether the user is a student or an instructor. The software then queries the database to retrieve previously stored preferences and user information which can then be queried at any point remotely. If the client is a student, the software checks to see if the instructor is logged in and contacts the instructor (through the Enterprise Communication Server) to obtain the “state” of the instructor (a list of different modes of controls and control “states”), it then adapts to it according to the instructor state. If the client is an instructor, students are notified at 510 that the instructor has logged in.

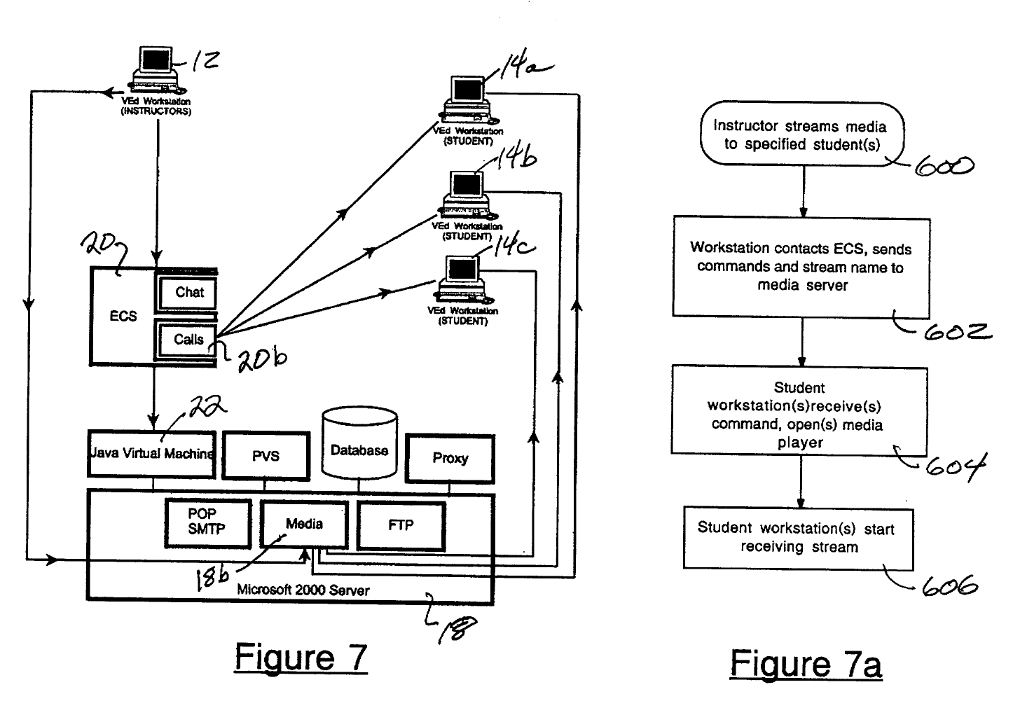

FIGS. 7 and 7a illustrate how media is streamed. Whenever the instructor 12 starts streaming any media 600 to the students, the instructor software sends a command 602 to the Enterprise Communication Server 20 which then contacts the targeted students and send them the command and the station and stream name 604. The instructor software then starts streaming the media to the Multimedia Server 18b which then starts a live broadcast of the media stream. The student software then opens the multimedia player 604 which receives the stream from the multimedia server 606.

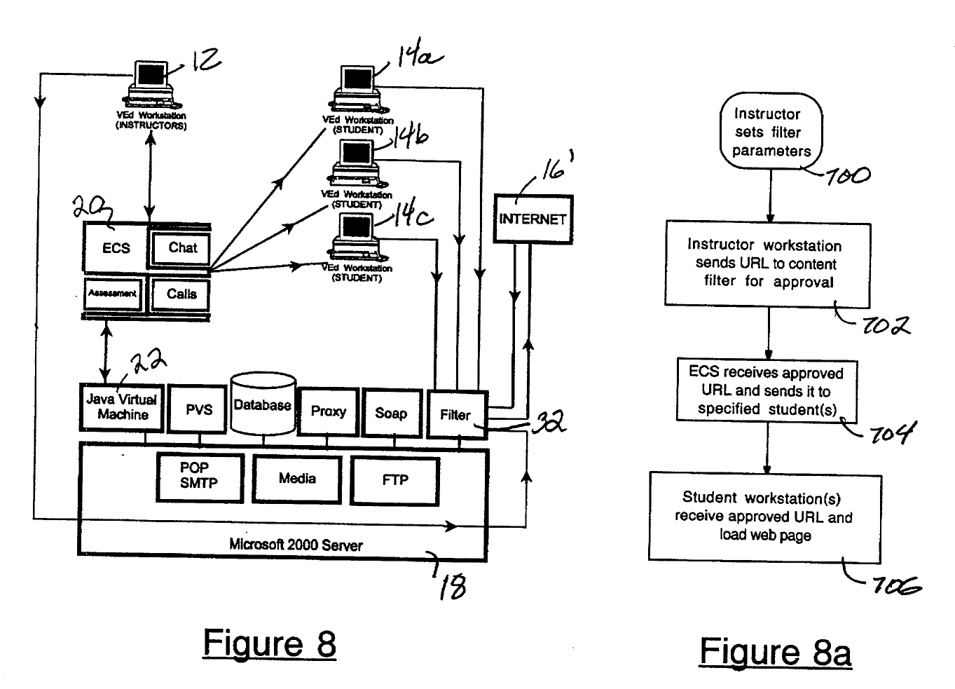

FIGS. 8 and 8a illustrate content filtering according to the invention. There are two types of filters. One can be set at an institution level and one can be set by the instructor on a course or even student level. The institution-level filter consists of a list of restricted web sites set on the filter server 32 or a list of keywords that can trigger the restriction mechanism inside a web page. This filter can be set once or updated as desired by an administrator and it will apply automatically every time the student navigates to a web site. This allows adult content (for example) to be filtered out with a combination of URLs and keywords contained within the HTML code of the web page. The instructor-level filter is a list of web sites that she or he creates and uses to “restrict” access to web sites which are not contained in the list. The instructor-level filter works in the following way. The instructor activates the filter 700 for the chosen students. The software sends the command along with a list made up of at least one web site to the Enterprise Communication Server 20 which checks 702 the filter server 32 for approval. The ECS 20 receives the approved URL(s) and sends the URL(s) to the specified student(s) 704. The student(s) may then view the approved URL(s) 706. Whenever the student tries to navigate to a URL, the software compares the web site domain and either denies or allows access to the web site. Both filters can be complimentary and can be used together or separately.

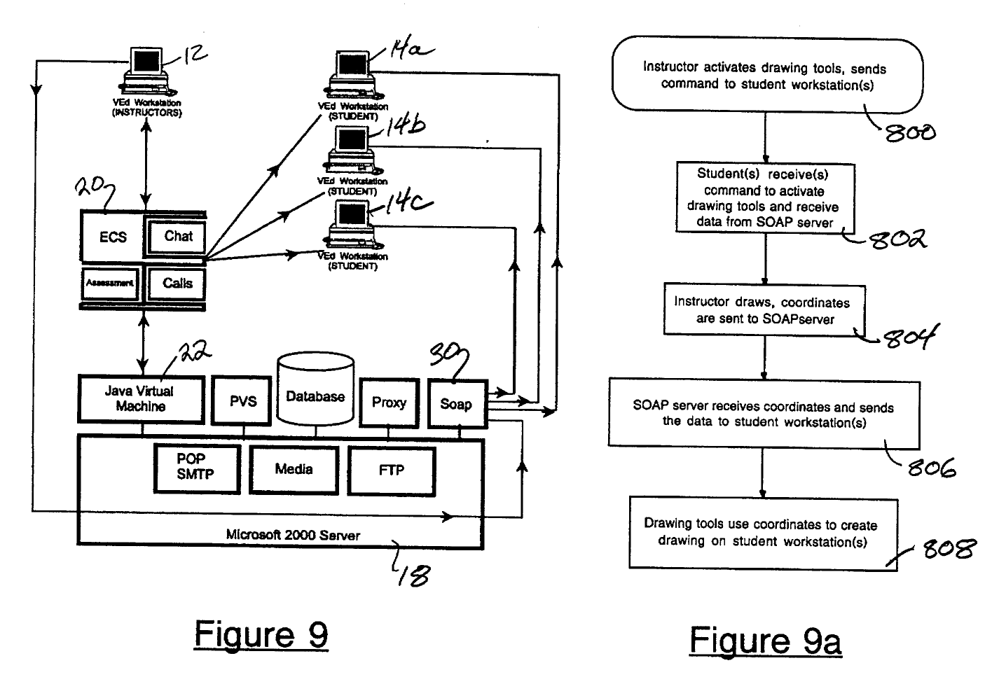

FIGS. 9 and 9a illustrate the synchronized drawing tools according to the invention. The drawing tools function in the following manner. The instructor activates the drawing tools 800 and starts drawing on the screen. As soon as the drawing tools are activated, the software sends the command to the Enterprise Communication Server 20 and the Enterprise Communication Server sends the command to the students. Immediately after the command is received by the student software 802, the software starts listening to the SOAP server 30 which then continuously (whenever the instructor draws something 804) sends a stream of drawing information (coordinates, tool type, line thickness, color, etc) 806 received from the instructor. The data is then used to reconstruct the drawing on the student's workstation 808.

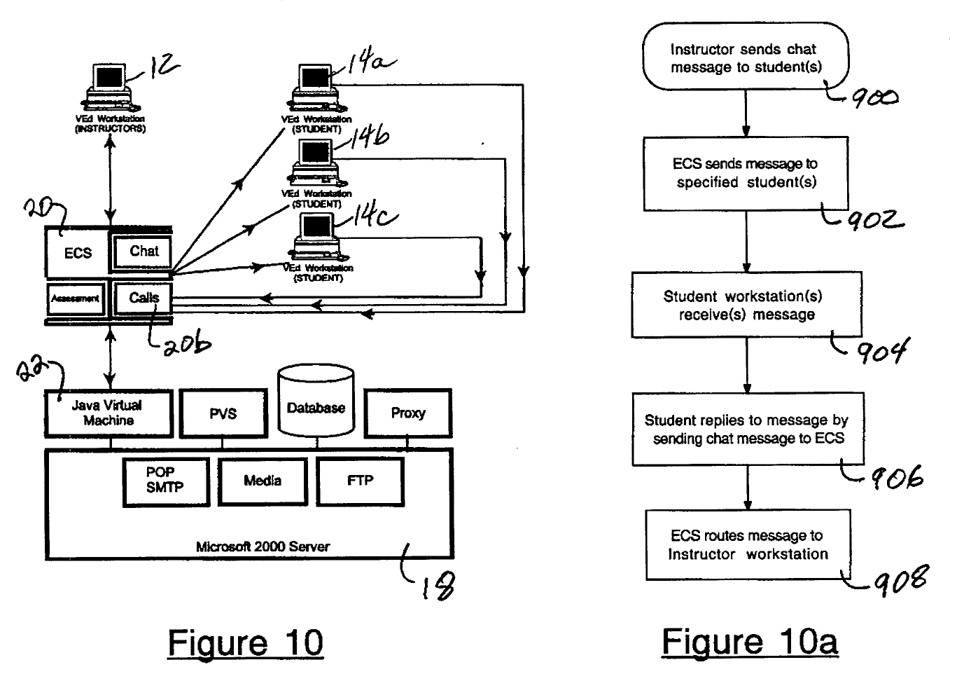

FIGS. 10 and 10a illustrate chat messaging between instructor and student(s) according to the invention. The instructor sends a message to all the students or any particular student 900. The message is then sent to the Enterprise Communication Server. The Enterprise Communication Server then goes through the list of students the message is supposed to be sent to and sends it to them 902. When the message is received 904, the student software displays the message and the name of the user who sent it. The student may reply to the massage at 906 and the ECS will route the message to the instructor at 908.

There are six types of messages supported by the software of the invention: (1) a course-level messages which can be viewed by everybody in the classroom; (2) a private (one-to-one) message which can be seen only by the destination user; (3) a group message which can only be viewed within the group of students created by the instructor; (4) a system-level message which informs all the users logged in to the Enterprise Communication Server of a potential problem which might affect them (this can be issued by the Enterprise Communication Server itself if it detects a critical problem that might prevent it from functioning properly); (5) an administrator message which can be sent to any user or to everyone by an administrator (this can be used, for example, to inform all the connected users that Enterprise Communication Server has to be shutdown for maintenance); and (6) a local, software-generated, message which is displayed to inform the user of any relevant information (only the current user of this particular software can view the message).

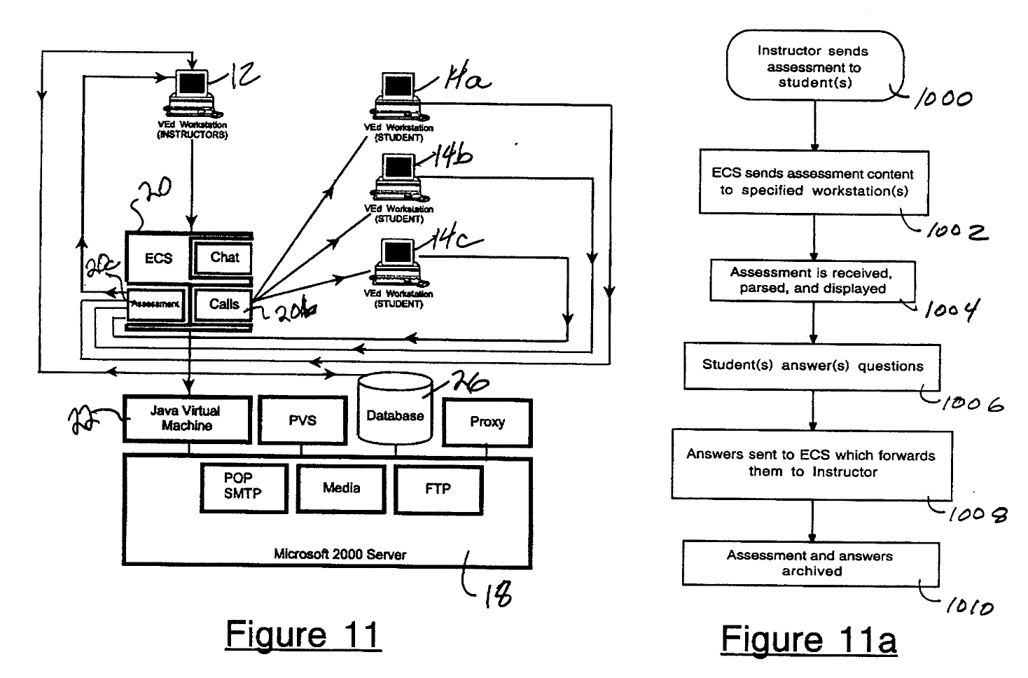

FIGS. 11 and 11a illustrate the student assessment function of the invention. The assessment is first created by the instructor. The instructor has the option to retrieve a previously created assessment which is retrieved from the database 26 and display it or to create a new one. He also has the option of storing (archiving) the quiz (assessment) for later retrieval. When the instructor is finished either creating or retrieving the assessment, the assessment is then stored in a table (question text, question text, answers, correct answer) and then sent 1000 along with the command to the Enterprise Communication Server which sends it to the relevant students 1002. The students' software then displays the assessment to the students 1004. Once all the questions have been answered 1006, the answers are sent at 1008 to the ECS 20c which forwards them to the instructor 12. The questions and answers are automatically archived at 1010. According to the invention, there is an optional timer which automatically sends the assessment answers from the student to the ECS on its expiration. The stored assessments are used to display several charts and reports which show the instructor and/or student graphically and explicitly the student's performance. According to one aspect of the invention performance is measured on a per-student and per-question basis.

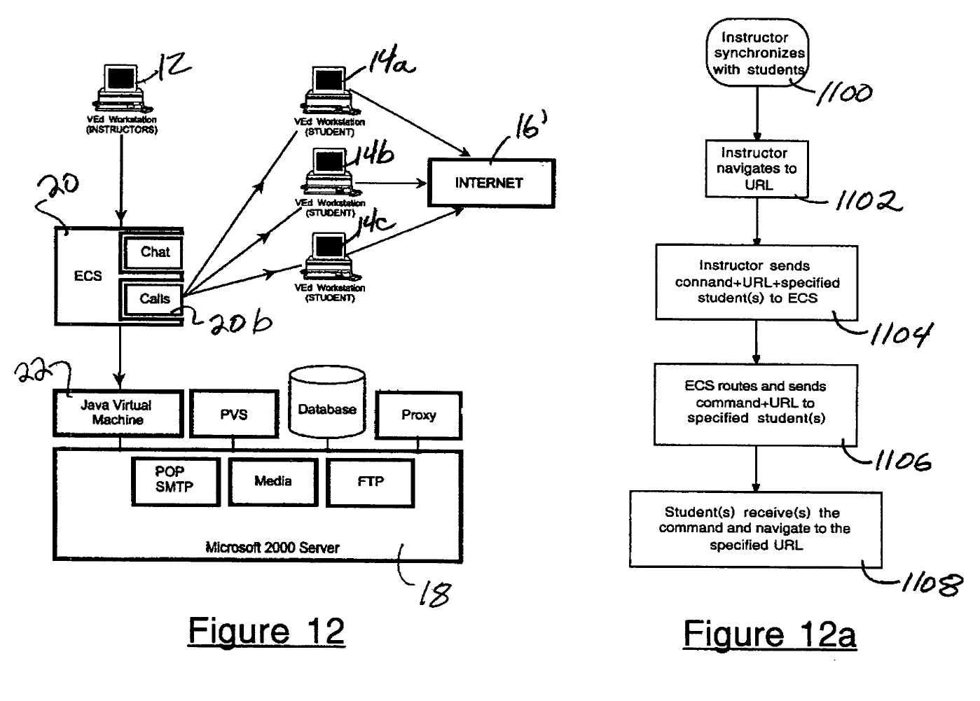

FIGS. 12 and 12a illustrate an alternate embodiment of web page synchronization according to the invention. The instructor 12 synchronizes with students 14a-14c at 1100. The instructor 12 navigates to a URL at 1102. The instructor then sends a command, URL, and list of students to the ECS 20 at 1104. The ECS 20 routes and sends the command and the URL to the specified students at 1106. The students receive the command and the URL at 1108.

As mentioned above, the invention can be implemented with off the shelf hardware and software utilizing the JAVA code shown in the CDROM appendix. The database 26 is preferably either a Microsoft SQL Server 2000 or, alternately, a MySQL for lower costs. All queries are preferably stored on the database in the form of stored procedures in the case of Microsoft SQL server 2000 or simply as SQL commands stored within the application when using MySQL. The Enterprise Communication Server 20 is a preferably a JAVA RMI server running on the Java Runtime Environment 1.4.0.

The client applications shown in the appendix were all built with the JAVA Development Kit 1.3.1 and using SWING for the interface. The Multimedia Services 18b utilize the latest version of Microsoft's Windows Media technologies (Windows Media Server, Windows Media Encoder). File Transfer is handled by the standard FTP code available in the JAVA Runtime Environment 1.3.1 on the client side and by Microsoft Internet Information Server on the server-side 18c. It should be noted, however, that the FTP can be handled by any FTP server. The drawing tools use a combination of XML tags and a Simple Object Access Protocol server (handled by Apache Tomcat or Microsoft SOAP Interop server) 30 to send and receive drawing data. E-mail is handled on the client-side by Sun's JAVA Mail package and on the server-side by Microsoft Internet Information Server 18a. The Content Filter 32 is handled by Microsoft Internet Acceleration Server. The Proxy Server 28 is Microsoft's Internet Acceleration Server or Squid Web Proxy Cache.

The web browser utilized by the client software of the invention is ICESoft Technologies' 100% pure JAVA ICEBrowser or Microsoft Internet Explorer. The deployment (installation) is preferably done using ZEROG's InstallAnywhere 4.5 and above JAVA-based multi-platform installation solution. The JAVA level 4 SQL drivers used by the clients to communicate with the SQL server are implemented using Atinav's AVEConnect SQL drivers version 2.5 and above.

All of the software illustrated in the CDROM appendix is designed to run on any computer running Microsoft Windows 98 and above or Apple Macintosh OS 9.0 and above. All the servers are either part or can run on the Microsoft Windows 2000 Server.

There have been described and illustrated herein several embodiments of methods and apparatus for distance learning utilizing the world wide web. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as so claimed.

| | | |
|---|---|---|
| FTPStudentTest.java | 1248 | March 25, 2002 |
| Jutil.java | 10656 | March 25, 2002 |
| _Broadcast.java | 1089 | March 19, 2002 |
| Broadcast.java | 482 | April 29, 2002 |
| _MPlayer.java | 2227 | March 19, 2002 |
| MPlayer.java | 484 | March 19, 2002 |
| Class_OpenFile.java | 951 | March 20, 2002 |
| AVReceive2.java | 12832 | March 20, 2002 |
| Browser.java | 49271 | April 29, 2002 |
| ChatPanel.java | 2298 | April 29, 2002 |
| Class_OpenFile.java | 527 | March 20, 2002 |
| ClassFoldersDialog.java | 8183 | April 29, 2002 |
| ClassRoomView.java | 21094 | March 28, 2001 |
| CoursesDialog.java | 16004 | March 27, 2001 |
| CoursesPasswordsDialog.java | 7737 | April 29, 2002 |
| EmailDetail.java | 1413 | March 25, 2002 |
| FtpDetail.java | 1289 | April 2, 2002 |
| FTPSend.java | 6725 | March 4, 2002 |
| InBox.java | 4414 | March 23, 2002 |
| InstructorRegistrationWizard.ja | 26603 | April 29, 2002 |
| Interface.java | 101225 | April 29, 2002 |
| LoginDialog.java | 15039 | April 24, 2002 |
| MesgWindow.java | 4207 | April 17, 2002 |
| MesgWindowSp.java | 18624 | April 25, 2002 |
| MiscMail.java | 2978 | April 29, 2002 |
| Multimedia Player.java | 2704 | March 28, 2002 |
| MyCellRenderer.java | 1110 | April 29, 2002 |
| NewClassDialog.java | 5409 | April 29, 2002 |
| NewFolderDialog.java | 3568 | April 29, 2002 |
| OpenFile.java | 2555 | March 23, 2002 |
| OutBox.java | 14163 | April 2, 2002 |
| PreferencesDialog.java | 22792 | March 23, 2002 |
| QuestionArchive.java | 7880 | March 26, 2002 |
| QuestionDialog.java | 45305 | March 27, 2001 |
| RemoteDialog.java | 5793 | April 29, 2002 |
| ReportDialog.java | 22970 | March 14, 2002 |
| SendMail.java | 8478 | March 28, 2001 |
| SplashWindow.java | 1306 | April 29, 2002 |
| Stream.java | 2650 | March 28, 2001 |
| StudentBrowser.java | 23916 | March 27, 2002 |
| StudentRegistrationWizard.java | 24345 | April 29, 2002 |
| TakeAttendance.java | 1757 | April 29, 2002 |
| TimerDialog.java | 12371 | March 20, 2002 |
| Tooltip.java | 3470 | March 26, 2002 |
| UserInfoWindow.java | 5467 | March 24, 2002 |
| UserList.java | 2190 | April 29, 2002 |
| Ved.java | 5171 | April 29, 2002 |
| VideoTransmit.java | 7262 | April 29, 2002 |
| ViewAttendance.java | 8322 | April 29, 2002 |
| VisitedLinks.java | 1803 | April 29, 2002 |
| TestFolders.java | 2446 | February 8, 2002 |

In the directory entitled Highlighted code are the following Adobe ®
Acrobat ® files:

| | | |
|---|---|---|
| Browser.pdf | 44951 | May 4, 2002 |
| ClientHandler.pdf | 2412 | May 4, 2002 |
| ECSClient.pdf | 13634 | May 4, 2002 |
| Interface.pdf | 75848 | May 4, 2002 |
| Server.pdf | 20076 | May 4, 2002 |
| ServerHandler.pdf | 2992 | May 4, 2002 |

Copy 2: Identical to Copy 1.

1. A system for computer aided instruction, comprising:
a communications network;
at least one instructor workstation coupled to said communications network;
at least one student workstation coupled to said communications network; and
synchronization means for synchronizing the display of a web page on the instructor workstation with the display of a web page on the student workstation.

2. The system according to claim 1, wherein:
said synchronization means includes a proxy server for storing the web page.

3. The system according to claim 2, wherein:
said synchronization means includes means for downloading the web page to the proxy server and means for sending the web page URL to the student workstation.

4. The system according to claim 1, wherein:
said synchronization means includes means for transmitting the web page URL from the instructor workstation to the student workstation.

5. The system according to claim 1, further comprising:
an electronic mail server coupled to said network for communicating electronic mail between the instructor workstation and the student workstation.

6. The system according to claim 1, further comprising:
an file transfer protocol server coupled to said network for transferring files between the instructor workstation and the student workstation.

7. The system according to claim 1, further comprising:
access control means coupled to said network for limiting access by the student workstation to the world wide web.

8. The system according to claim 7, wherein:
said access control means includes a list of prohibited URLs.

9. The system according to claim 7, wherein:
said access control means includes a list of approved URLs.

10. The system according to claim 7, wherein:
said access control means includes a list of keywords which prevent a web page from being displayed.

11. The system according to claim 1, further comprising:
user authentication means for preventing an unauthorized user from accessing the network.

12. The system according to claim 11, wherein:
said user authentication means includes means for determining whether a user is already accessing the network.

13. The system according to claim 1, further comprising:
a multimedia server coupled to said network for streaming media to the student workstation.

14. The system according to claim 13, wherein:
the multimedia server is controlled by the instructor workstation.

15. The system according to claim 1, further comprising:
a drawing command server coupled to the network wherein drawings drawn on the instructor workstation are reduced to commands transmitted by the drawing server to the student workstation such that the drawing on the instructor workstation is reproduced on the student workstation.

16. The system according to claim 1, further comprising:
database means coupled to the network.

17. The system according to claim 16, wherein:
the database means includes an archive of student assessments.

18. The system according to claim 17, wherein:
each student assessment includes a plurality of questions and a corresponding plurality of correct answers.

19. The system according to claim 17, wherein:
said archive of student assessments includes test answers from a plurality of students.

20. The system according to claim 1, further comprising:
student assessment means whereby a plurality of questions are sent to the student workstation and answers entered at the student workstation are automatically sent to the instructor workstation.

21. The system according to claim 20, wherein:
the student assessment means includes a timer whereby answers are sent automatically on the expiration of the timer.

22. A system for computer aided workgroup collaboration, comprising:
a communications network;
at least one group leader workstation coupled to said communications network;
at least one group member workstation coupled to said communications network; and
synchronization means for synchronizing the display of a web page on the group leader workstation with the display of a web page on the group member workstation.

23. The system according to claim 22, wherein:
said synchronization means includes a proxy server for storing the web page.

24. The system according to claim 23, wherein:
said synchronization means includes means for downloading the web page to the proxy server and means for sending the web page URL to the group member workstation.

25. The system according to claim 22, wherein:
said synchronization means includes means for transmitting the web page URL from the group leader workstation to the group member workstation.

26. The system according to claim 22, further comprising:
an electronic mail server coupled to said network for communicating electronic mail between the group leader workstation and the group member workstation.

27. The system according to claim 22, further comprising:
a file transfer protocol server coupled to said network for transferring files between the group leader workstation and the group member workstation.

28. The system according to claim 22, further comprising:
access control means coupled to said network for limiting access by the group member workstation to the world wide web.

29. The system according to claim 28, wherein:
said access control means includes a list of prohibited URLs.

30. The system according to claim 28, wherein:
said access control means includes a list of approved URLs.

31. The system according to claim 28, wherein:
said access control means includes a list of keywords which prevent a web page from being displayed.

32. The system according to claim 22, further comprising:
user authentication means for preventing an unauthorized user from accessing the network.

33. The system according to claim 32, wherein:
said user authentication means includes means for determining whether a user is already accessing the network.

34. The system according to claim 22, further comprising:
a multimedia server coupled to said network for streaming media to the group member workstation.

35. The system according to claim 34, wherein:
the multimedia server is controlled by the group leader workstation.

36. The system according to claim 22, further comprising:
a drawing command server coupled to the network wherein drawings drawn on the group leader workstation are reduced to commands transmitted by the drawing server to the group member workstation such that the drawing on the group leader workstation is reproduced on the group member workstation.

37. The system according to claim 22, further comprising:
database means coupled to the network.

38. The system according to claim 37, wherein:
the database means includes an archive of group member assessments.

39. The system according to claim 38, wherein:
each group member assessment includes a plurality of questions and a corresponding plurality of correct answers.

40. The system according to claim 38, wherein:
said archive of group member assessments includes test answers from a plurality of group members.

41. The system according to claim 22, further comprising:
group member assessment means whereby a plurality of questions are sent to the group member workstation and answers entered at the group member workstation are automatically sent to the group leader workstation.

42. The system according to claim 41, wherein:
the group member assessment means includes a timer whereby answers are sent automatically on the expiration of the timer.
